(19) United States
(12) Patent Application Publication
(10) Pub. No.: US 2019/0100306 A1
(43) Pub. Date: Apr. 4, 2019

(54) PROPELLER CONTACT AVOIDANCE IN AN UNMANNED AERIAL VEHICLE

(71) Applicant: Intel IP Corporation, Santa Clara, CA (US)

(72) Inventors: Daniel POHL, Puchheim (DE); Roman SCHICK, Krailling (DE)

(21) Appl. No.: 15/719,581

(22) Filed: Sep. 29, 2017

(51) Int. Cl. B64C 39/02; B64D 47/08

(52) U.S. Cl. CPC B64C 39/024; B64D 47/08; B64C 2201/042; B64C 2201/165; B64C 2201/108

(57) ABSTRACT

An unmanned aerial vehicle comprising one or more sensors, configured to receive data from an area surrounding the unmanned aerial vehicle; one or more processors, configured to detect movement in a region surrounding the unmanned aerial vehicle using the sensor data; assess the detected movement for fulfillment of a predetermined movement threshold; and upon fulfillment of the predetermined movement threshold, switch between a first operational mode and a second operational mode.

### TECHNICAL FIELD

Various embodiments relate generally to a sensor system to detect movement in the vicinity of an unmanned aerial vehicle (“UAV”).

### BACKGROUND

As UAV use becomes more widespread, so too has the frequency of injuries from UAVs increased. Each UAV model includes a plurality of propellers, which are often quite sharp and rotate at very high speeds. These rotating propellers constitute significant danger to living beings. Many UAV models include a shielding device that at least partially obstructs access to the propellers, thereby providing a measure of safety against contact with moving propellers. These shielding devices, however, decrease aerodynamics and reduce battery life. Where such shielding devices are removed, however, there is virtually no guard against accidental contact with the moving propellers, thereby increasing the risk of injury to a living being.

### SUMMARY

An unmanned aerial vehicle is disclosed wherein including one or more sensors, configured to receive data from an area surrounding the unmanned aerial vehicle; one or more processors, configured to detect movement in a region surrounding the unmanned aerial vehicle using the sensor data; assess the detected movement for fulfillment of a predetermined movement threshold; and upon fulfillment of the predetermined movement threshold, switch between a first operational mode and a second operational mode.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 shows a conventional UAV with propeller guards;

FIG. 2 shows a UAV with exposed propellers;

FIG. 3 shows a UAV including one or more sensors, according to an aspect of the disclosure;

FIG. 4 shows a UAV with a plurality of sensing regions including propeller coverage;

FIG. 5 shows a voxel map motion detecting procedure, according to an aspect of the disclosure;

FIG. 6 shows a depth image motion detection procedure, according to an aspect of the disclosure;

FIG. 7 shows a device for propeller contact avoidance in an unmanned aerial vehicle; and

FIG. 8 shows a method for propeller contact avoidance in an unmanned aerial vehicle.

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration.” Any embodiment or design described herein as “exemplary” is not necessarily to be construed as preferred or advantageous over other embodiments or designs.

Throughout the drawings, it should be noted that like reference numbers are used to depict the same or similar elements, features, and structures.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

UAVs pose a risk of injury to living beings through contact with moving propellers. Contact between living beings and moving propellers can occur both in flight and before the UAV becomes airborne. Regarding ground injuries, UAVs are often initiated or started remotely and from a significant distance, where it may not be apparent to the pilot that a living being is nearby. This can occur, for example, where the pilot is remotely located, but a living being is inspecting the UAV for flightworthiness. Because the propellers include a plurality of sharp, rapidly rotating blades, contact with the propellers can result in significant injury.

This danger of accidental contact with moving blades has been mitigated somewhat by the presence of a guard surrounding or partially covering the propeller. Although these guards were primarily designed to avoid contact between a moving propeller and other airborne UAVs, they provide an additional benefit of decreased risk to living beings, whether in flight or preflight.

These guards may be undesirable, however, given their reduction of aerodynamic efficiency and therefore decreased battery life. Mechanical propulsion by propellers demands the vast majority of a UAV's battery resources, and therefore reduction in aerodynamic efficiency related to the propellers may carry a significant cost. Many professional UAV models have eliminated these guards due to the need for maximum aerodynamic efficiency. Considering the guards' reduction in efficiency, and the absence of said guards in many models, an alternative method and device for avoiding contact with moving propellers is disclosed herein.

A method and UAV device are disclosed to preclude starting of the UAV motor when the UAV is in the vicinity of moving objects, or to reduce propeller speed such that the danger to living beings of injury from propeller contact is mitigated. According to one aspect of the disclosure, one or more processors analyze data from one or more sensors to detect objects within a vicinity of the UAV. The sensors may be cameras to detect visual information in a region surrounding a UAV. The cameras may operate using any portion or combinations of portions of the light spectrum, whether visible or invisible, including, but not limited to, the visible spectrum, infrared, or otherwise.

The number and location of sensors may be selected based on the needs of any given implementation, without limitation. Sensors may be placed to obtain sensory input from the fore, aft, port, starboard, top and/or bottom regions of the UAV. Additional sensors may be placed to obtain sensory information from other directions. Additional sensors may also be used to reduce or limit a blind spot in the vicinity of the UAV, or any area from which sensory information is not otherwise available.

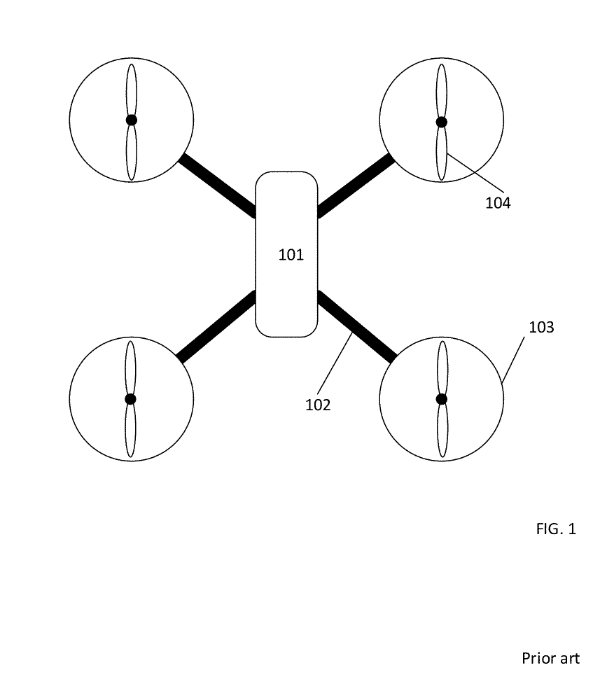

FIG. 1 shows a conventional UAV with a known propeller guard. The UAV includes a body 101, a frame including or essentially consisting of a plurality of frame arms 102, a plurality of propeller guards 103, and a corresponding plurality of propellers 104. The propeller guards 103 are conventionally placed above, below, or surrounding a propeller, and reduce the risk of damage to other UAVs or flying objects through contact with propellers, and reduce the risk of injury to persons on the ground in the vicinity of the UAV at the time of propeller activation. The propeller guards 104 are known to increase drag or otherwise reduce the aerodynamic efficiency of the UAV. This reduction in efficiency results in increased power burden and lessens the UAV's battery life.

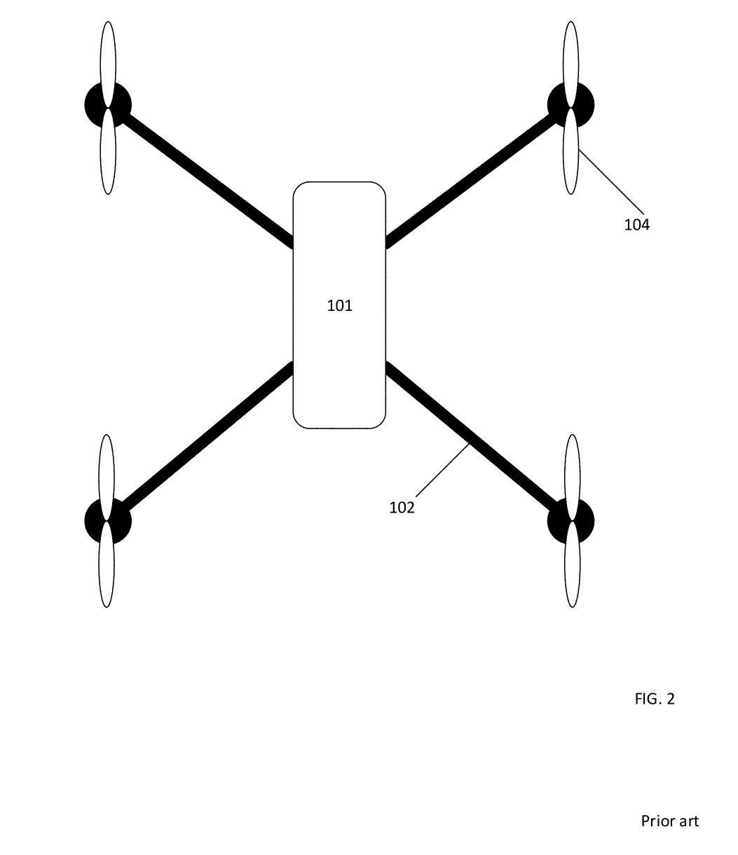

FIG. 2 shows a UAV without propeller guards, according to one aspect of the disclosure. The UAV includes a body 101, a frame comprised of a plurality of frame arms 102, and a plurality of propellers 104. The elimination of propeller guards reduces drag and increases aerodynamic efficiency, thereby preserving and lengthening battery life. The absence of propeller guards may increase the risk of injury or damage resulting from contact with a moving propeller.

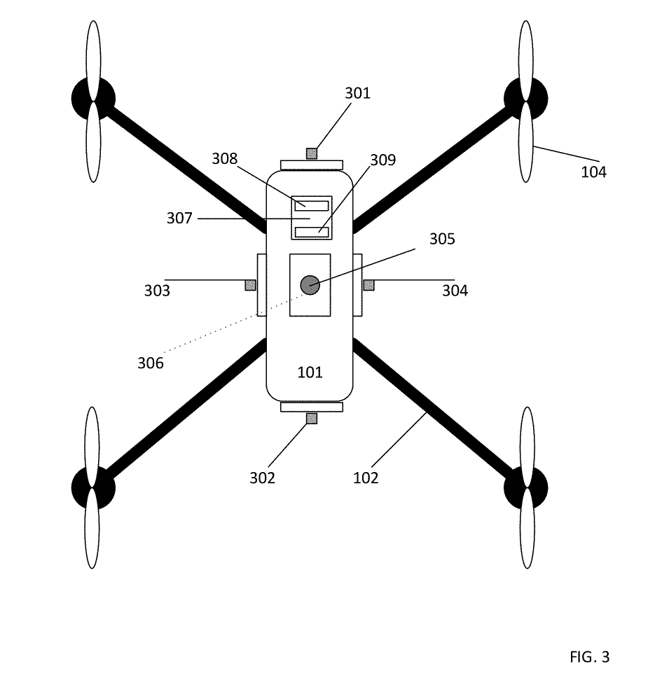

FIG. 3 shows a UAV with a plurality of sensors according to an aspect of the disclosure. In this figure, a conventional UAV including a body 101, a frame further including a plurality of frame arms 102, and a plurality of propellers 104, further includes a plurality of sensors for gathering sensory information of an area surrounding the UAV 301, 302, 303, and 304. According to one aspect of the disclosure, sensors may be placed on any combination of surfaces in the fore, aft, port, starboard, top, or bottom regions of the UAV. In this figure, sensor 301 has a fore placement, sensor 302 has an aft placement, sensor 303 has a port placement, sensor 304 has a starboard placement, sensor 305 has a top placement, and sensor 306 (not displayed) has a bottom placement. The data received by the one or more sensors is processed by a sensing and control device 307, which includes one or more processors 308 and optionally includes a memory 309.

Although the sensors in FIG. 3 are shown as being placed on the body of the UAV, the sensors may be placed anywhere on the UAV including the body, the frame, or above or below one or more propellers.

It is expressly considered that the number of sensors can be reduced or expanded to meet the demands of the implementation. That is, in some applications, it may be most desirable to limit the sensors to a fore, port, aft, and starboard sensor, so as to detect regions within the vicinity of the propellers. In other applications, a single 360° sensor may be placed on the top or the bottom of the UAV. These examples are provided for illustrative purposes and are not intended to be limiting. It is expressly contemplated that sensors may be placed in any combination or location.

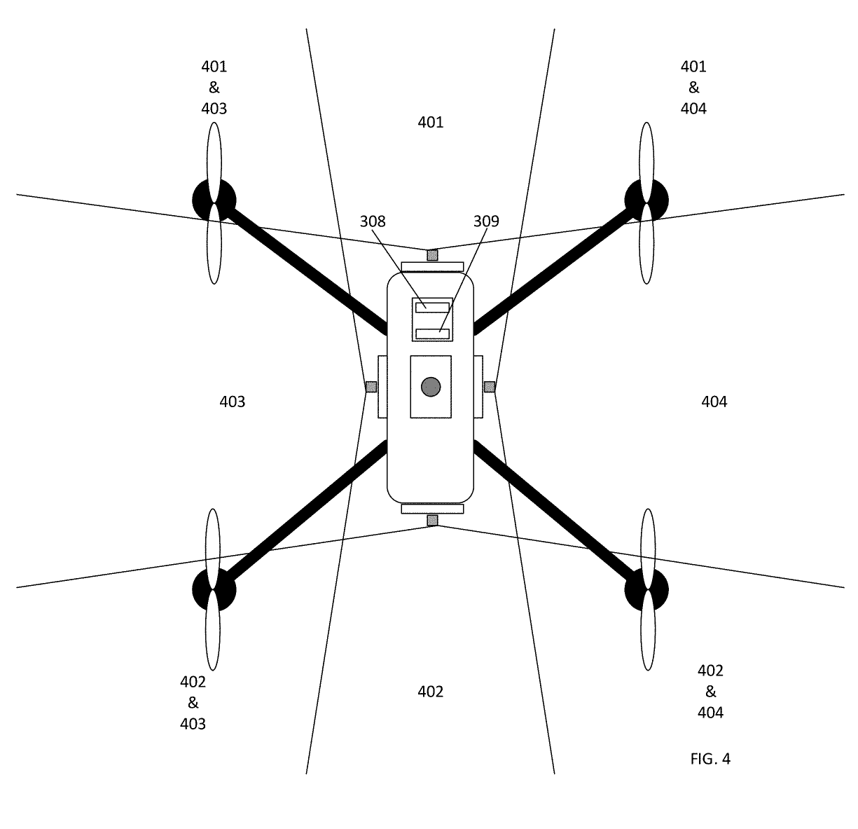

FIG. 4 shows sensor data regions according to an aspect of the disclosure. Data region 401 corresponds with sensor 301. Data region 402 corresponds with sensor 302. Data region 403 corresponds with sensor 303. Data region 404 corresponds with sensor 304. Sensor 305 corresponds with a data region above the UAV (not shown). Sensor 306 corresponds with the data region below the UAV (not shown). As shown, placement of sensors in this manner allows for the receipt of sensory information from nearly the entire region surrounding the UAV. Depending on the placement of sensors as desired for the given implementation, it is possible to obtain sensory information from areas surrounding each propeller, and thereby assessing said sensory data to obtain information about objects within the vicinity of a propeller. FIG. 4 additionally includes one or more processors 308 and an optional memory 309.

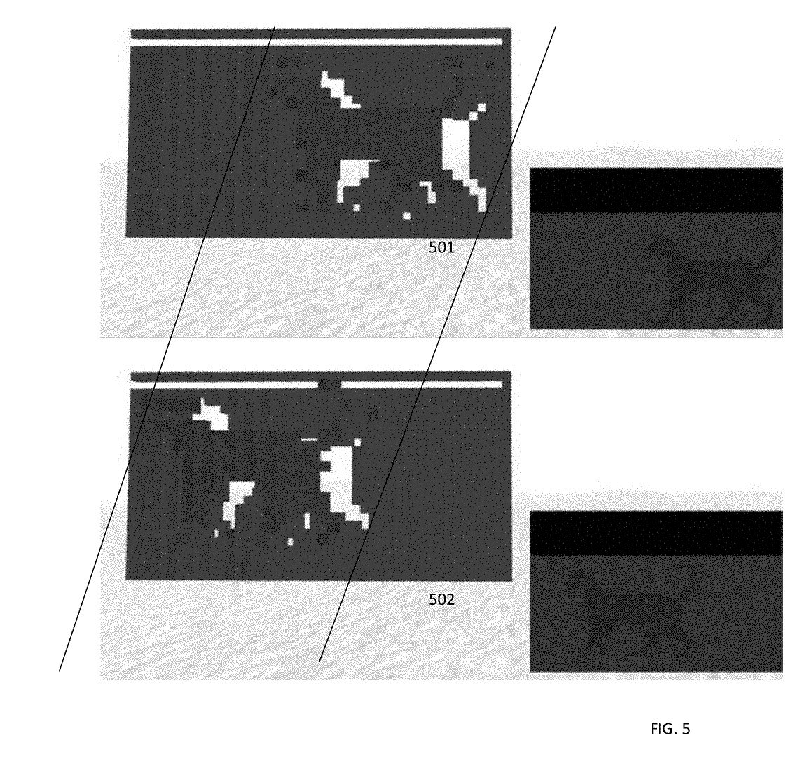

FIG. 5 shows a voxel map assessment of sensory data to assess movement. A voxel includes graphic information that defines a three-dimensional volume. Unlike a pixel, which defines a two dimensional space based on an x-axis and a y-axis, a voxel requires the addition of a z-axis to define the space in terms of depth. Voxels may be configured to carry additional information, such as color or density. Voxels may be determined from a three-dimensional camera (depth camera) or a combination of image sensors or cameras providing image overlap. The obtained image data may be processed by a voxel engine to transform the image data into voxels. The voxel engine may be one or more processors, or a non-transitory computer readable medium. The translation of image data into voxels can be carried out using rasterization, volume ray casting, splattering, or any other volume rendering method. Once translated, the voxels are stored in a voxel map, which preserves three-dimensional image sensor data.

According to one aspect of the disclosure, sensory information obtained from one or more sensors may be interpreted using a voxel map, which may include the sensory information on a grid within three-dimensional space. 501 shows a voxel map image of a cat as interpreted from received sensory information from a sensor. According to one aspect of the disclosure, information from a sensor is converted into a voxel map as described above and stored in memory. Updated sensory information is then obtained and converted into a subsequent voxel map, which is compared with the voxel map and memory. 502 shows an updated voxel map showing a cat in a different location. In this case, original voxel map 501 is stored in memory and compared with the updated voxel map 502. A comparison shows movement of the cat. The one or more processors are configured to recognize movement of objects within a predetermined distance of the UAV by comparing image data, whether in voxel map or otherwise, and identify a difference in image data from a first period compared to a second period. In the context of a voxel map, the one or more processors are configured to identify changes in voxel data between a first voxel map and a second voxel map. Because each voxel includes three-dimensional locational data, comparison of voxel maps allows for the one or more processors to ascertain movement in a vicinity of the UAV, whether the movement is one-dimensional, two-dimensional, or three-dimensional. For example, in FIG. 5, the one or more processors determine movement of the cat based on a comparison of the first voxel map and the second voxel map. The one or more processors also determine a distance of the voxels associated with the movement, and where the corresponding voxels correspond to at least a predetermined distance from the UAV, the one or more processors switch from a first operational state to a second operational state, thereby preventing startup. Prevention of start up avoids injury to nearby living beings from an initiation of the UAV's propellers while a living being is in close proximity to the UAV.

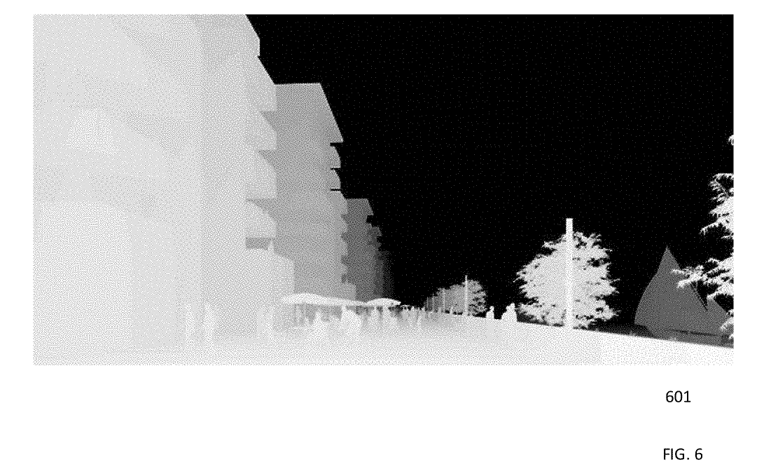

FIG. 6 shows received sensory information translated into a depth image 601 for assessment of a distance from the UAV. A depth image contains information to indicate a relative distance of objects displayed in the image. This distance information may be, but is not limited to, colors or shading to depict a relative distance from a sensor. Depth map may be constructed from a depth-sensing camera or a stereo image. Said depth map construction may be achieved using a depth map engine, which may be one or more processors or a non-transitory computer readable medium configured to create a depth map from a stereo image or an image including depth information.

In FIG. 6, element 601 shows objects that are closer are depicted as being lighter, and objects farther away are depicted as being darker. Thus, a shading or intensity of an object provides information about the distance of said object from a sensor. According to an aspect of the disclosure, a depth image may be used to provide the one or more processors with information about the distance of an object, particularly a moving object. A depth image may provide information to assess the distance and determine whether the distance of a moving object exceeds a predetermined threshold, thereby requiring triggering of the switch and disabling of the UAV's motors.

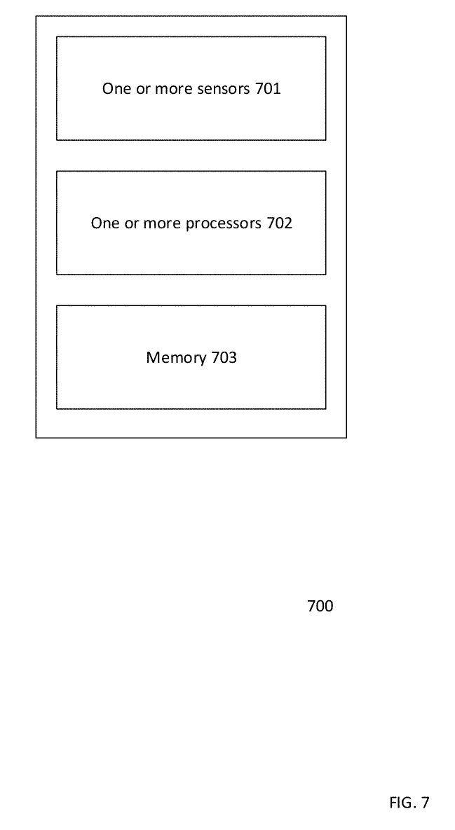

FIG. 7 shows a portion of a UAV configured to avoid contact with moving propellers 700 according to one aspect of the disclosure. This device 700 includes one or more sensors 701, configured to receive data from an area surrounding the unmanned aerial vehicle; one or more processors 702, configured to detect movement in a region surrounding the unmanned aerial vehicle using the sensor data; assess the detected movement for fulfillment of a predetermined movement threshold; and upon fulfillment of the predetermined movement threshold, switch between a first operational mode and a second operational mode. The device 700 may further include an optional memory 703, configured to store the locational mapping data.

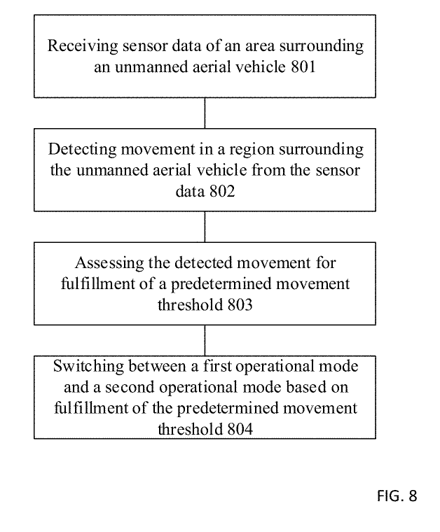

FIG. 8 shows a method for propeller contact avoidance in an unmanned aerial vehicle including receiving sensor data of an area surrounding an unmanned aerial vehicle 801; detecting movement in a region surrounding the unmanned aerial vehicle from the sensor data 802 assessing the detected movement for fulfillment of a predetermined movement threshold 803, and switching between a first operational mode and a second operational mode based on fulfillment of the predetermined movement threshold 804.

Throughout the disclosure, the device used to obtain data from an area surrounding the vehicle is referred to as a sensor, which is selected to reflect that a variety of devices may be used to receive the requisite sensory input. The sensor is an image sensor capable of receiving a visual image. As such, the sensor may be a light receiving device, such as a camera, although without limitation to a type of camera and is specifically disclosed as including both still and video cameras, as well as cameras receiving light within the visible and invisible spectrum.

According to another aspect of the disclosure, the number of sensors may range from one to several. It is expressly contemplated that such sensors may receive sensory input from a variety of areas and area sizes. Depending on the given implementation, it may be desirable to select a sensor that receives only sensory input from a focused and narrow area. According to one aspect of the disclosure, such a sensor may be focused or aimed toward a single propeller, so as to obtain information about movement within a close vicinity to said propeller. According to another aspect of the disclosure, the sensor may be configured to receive sensory input from a wide area, which may range from an area larger than the focused beam described supra to an area as wide as 360° around the sensor. The sensor may be a 360°×180° sensor capable of receiving sensory information in 360° in one direction and in 180° in a perpendicular direction, such as in a hemispherical configuration. A UAV may be equipped with one or more 360°×180° sensors, which in the case of a plurality of such sensors, may be configured on opposite sides of the UAV to permit receipt of sensory information from all, or substantially all, directions. Moreover, multiple sensors may be combined to receive sensory information from a plurality of sources, or to combine several regions of sensory input to form one or more larger regions of sensory input. The number of sensors and the breadth of sensory input area may be chosen upon the installation and the needs of same, and may be selected based on factors such as, but not limited to, weight, aerodynamics, battery resources, and likelihood of contact with the moving object.

According to an aspect of the disclosure, the computational circuit may be any computational circuit capable of carrying out the logic and processing as described herein. The computational circuit may be located on the unmanned aerial vehicle, or may be located elsewhere and communicate with the unmanned aerial vehicle through one or more wireless connections.

Where motion is detected within a predetermined range of the unmanned aerial vehicle, the unmanned aerial vehicle is switched from a first operational mode to a second operational mode. The use of the word “switch” is not intended to connote a physical or mechanical switch, but rather a transition from a first operational mode to a second operational mode. As described infra, the first operational mode permits propeller engine initialization, and the second operational mode either precludes propeller engine initialization or permits propeller engine initialization only at a reduced speed which does not permit takeoff. The reduced speed may be considerably reduced from a speed enabling takeoff.

Wherein the one or more sensors are one or more cameras, the cameras may be, but are not limited to, still cameras, video cameras, infrared cameras and/or depth sensing cameras.

The one or more sensors are arranged to determine a region of sensory information surrounding the vehicle. According to one aspect of the disclosure, the one or more sensors are arranged to assess the presence of movement within a predetermined distance from one or more of the motors or propellers. According to another aspect of the disclosure, one or more 360° cameras are used to obtain visual data of at least one circumferential plane surrounding the unmanned vehicle, whereby the circumferential plane includes or is within the vicinity of one or more propellers.

In selecting positions for the sensors, and according to an aspect of the disclosure, sensors may be placed laterally to the unmanned vehicle, so as to provide sensory information from four quadrants extending from the vehicle. According to an aspect of the disclosure, said sensors may be placed to provide fore, aft, port, and starboard views from the unmanned vehicle.

According to another aspect of the disclosure, the unmanned vehicle may have only three motors/propellers, in which case the number of sensors used, and particularly where a sensor is not a 360° sensor, may be limited to three sensors, wherein each sensor provides a view of a propeller.

In addition, and regardless of the quantity of sensors for a lateral view, it may be desirable to provide one or more additional sensors to provide views from above or below the unmanned vehicle. Said plurality of sensors may provide additional information about a moving object within the vicinity of the unmanned vehicle. Said additional sensors may provide information about moving objects with a likelihood of imminent entry into the predetermined distance from a motor.

According to another aspect of the disclosure, movement may be ascertained by using a voxel map. According to this procedure, sensory information from the one or more sensors may be processed into a voxel map of regions surrounding the unmanned aerial vehicle. The voxel map provides simplified three-dimensional information about the vehicle's surroundings, and simplifies the analysis of movement. Where a voxel map is used, individual voxel's or clusters of voxel's may be assessed for changes in movement and for depth. Where movement is present, and where the depth or distance from the unmanned vehicle comes within a predetermined range, the switch may be triggered to disable one or more motors.

According to another aspect of the disclosure, movement may be ascertained by using a depth map. A depth map displays a visual image, with distances from the sensor being depicted as color or shading. Where a depth map is used to determine movement, a change in color or shading may represent movement based on a change in absolute distance between the object and the sensor. Because the pixels of a depth map are encoded with depth information expressed as a color or level of saturation, a change in color or saturation represents a change in distance from the sensor or sensors. According to one aspect of the disclosure, a color or saturation level may be associated with a predetermined distance from the one or more sensors.

According to another aspect of the disclosure, movement may be ascertained by comparing two images, such as, but not limited to, to voxel maps or to depth maps. Sensory input may be received from the one or more sensors periodically or continuously. As sensory input is received and processed into a map, said map may be stored in a memory and compared to a next or subsequent map to ascertain movement. A subsequent map may then replace the prior map in memory, or be added to the memory whereby the prior map is also maintained.

According to another aspect of the disclosure, movement detection may be carried out in real time by assessing changes in a map, rather than comparison of a contemporaneous map with a stored map. That is, pixels or clusters of pixels may be assessed for movement within the map. Furthermore, pixels or clusters of pixels may be assessed for changes in three-dimensional or distance information to indicate movement. This may be achieved without relying on data from a stored map, but rather by determining contemporaneous changes in received sensor data.

Where movement is detected and one or more motors are disengaged, it may be desirable to reengage the motors upon receiving and indicia of safety, that the moving object is no longer within the vicinity of the unmanned aerial vehicle. Accordingly, and upon disengagement of the one or more motors, a continued search for movement may be undertaken. Where no movement within the predetermined range from the unmanned aerial vehicle is detected, a timer may trigger for a predetermined length of time, during which periodic or continuous additional checks for movement will be carried out. When the timer expires, if no additional movement has been detected throughout the period of the timer, the one or more processors may cause the unmanned aerial vehicle to switch from the second operational mode to the first operational mode. This provides a mechanism for takeoff to be permitted once indicia of safety have been received.

According to another aspect of the disclosure, the procedure for propeller contact avoidance disclosed herein may be performed in accordance with the following algorithm:

| | |
|---|---|
| At time t=1: | (2) |

if(signal to start detected == true){

collect all voxels within vicinity of 3 meter( )
compare voxels with previous version of voxels from time t=0
if(more than 15% of the voxels changed their position){

dynamic movement = true;
deny engine start;

} else {

dynamic movement = false;
start engines;

}
}

According to another aspect of the disclosure, movement may be detected based on a change in position of a predetermined threshold of pixels or voxels. Such a predetermined threshold may reduce a risk of false positive of movement detection by requiring a threshold of pixels or voxels to change before determining that movement has occurred. According to one aspect of the disclosure, the percentage of changed pixels or voxels necessary to determine the presence of movement may be 15%. According to another aspect of the disclosure, the percentage of pixels or voxels necessary to determine the presence of movement may be less than or greater than 15%, without limitation.

According to one aspect of the disclosure, UAVs may frequently be equipped with one or more sensors for carrying out unrelated purposes, such as monitoring or otherwise creating still images or video. The use of one or more sensors for motion detection may permit the addition of a safety feature without the need for additional sensors to obtain sensory information for an area exterior to the UAV. This may provide additional safety features with little to no additional mass or computational costs.

In the event that one or more depth sensing cameras are used, each camera, whether alone or in combination, is able to determine a depth of an object ascertained as a moving object. In the event that a plurality of non-depth sensing sensors are used, the plurality of sensors may work in tandem to determine a depth of a moving object, where the moving object can be viewed by at least two sensors. Where a depth can be ascertained, the UAV may perform a two-step process, wherein the received image data is assessed for movement, and where movement is detected, a depth of the moving object is determined. This depth is then assessed relative to a predetermined threshold of depth, and where the moving object is within the predetermined threshold of depth, the UAV is caused to switch from a first operational mode to a second operational mode.

According to one aspect of the disclosure, the contact prevention device is configured to preclude start-up or otherwise reduce a propeller rotational velocity where dynamically moving objects are within a predetermined vicinity of the UAV.

According to another aspect of the disclosure, the contact prevention device is configured to preclude start-up or otherwise reduce a propeller rotational velocity where dynamically moving objects are within a predetermined vicinity of a sensor on the UAV.

According to one aspect of the disclosure, images from a plurality of sensors combine to provide a 360 degree view around the UAV.

According to one aspect of the disclosure, one or more sensors is capable of receiving depth information.

According to another aspect of the disclosure, a plurality of sensors are configured with overlapping image sensing areas, the overlap permitting assessment of depth information.

According to another aspect of the disclosure, depth information from the image data of the one or more sensors is used to create a voxel map of an area surrounding the UAV.

According to another aspect of the disclosure, the voxel map of the area surrounding the vehicle is tracked to detect dynamic movements around the UAV.

According to another aspect of the disclosure, a stored voxel map at t=0 is compared to a current or stored voxel map at time t=1 to asses changes in the voxel pattern and thus to determine movement.

According to another aspect of the disclosure, any changes in the voxel pattern may be sufficient movement to engage the switch and preclude motor startup.

According to another aspect of the disclosure, a change in voxel pattern must exceed a predetermined percentage of voxels for an area to engage the switch and preclude motor startup.

According to another aspect of the disclosure, the predetermined percentage of voxels for an area may be 15%.

According to one aspect of the disclosure, the unmanned aerial vehicle may be operated in one of two operational modes. The first operational mode permits engagement of the propeller engines and allows the propeller engines to reach velocities suitable for flight. All flight is carried out in the first operational mode. The second operational mode is a mode of restricted propeller velocity, which can range from zero to a velocity less than a flight velocity. The second operational mode may be prevent one or more propellers from rotating or may allow them to rotate slowly.

According to another aspect of the disclosure, the one or more processors may be configured to detect a presence of an object within a predetermined vicinity of the UAV and to assess whether the detected object fulfills a sensitivity threshold. This focus on detecting a mere presence of an object within a vicinity of the UAE without expressly requiring movement of the object to switch between operational modes bespeaks the potential undesirability of living beings within a vicinity of the UAV at startup. For instance, a stationary living being in a vicinity of the UAV at start up could rapidly move toward the UAV and risk injury or UAV damage. Furthermore, where the operational mode permits engine start up, and subsequently a living being moves toward the UAV and into a zone of danger, there may be a corresponding risk of injury. Accordingly, it may be desired to prevent startup when a living being is detected in the vicinity, even where that living being is stationary upon detection. The sensitivity threshold may be programmed based on a desired implementation. For example, the sensitivity threshold may be a proximity from the UAV, and depending on the installation may be smaller than the proximity considered where movement is required. That is, a stationary object may be permitted to be closer to the UAV than a moving object before switching of operational mode is required. The sensitivity threshold may be a size of the detected object. That is, a detected object in excess of a predetermined size threshold may trigger switching of the operational mode, whereas a detected object less than the predetermined size threshold may not trigger switching of the operational mode. Furthermore, the sensitivity threshold may be a combination of proximity and size, wherein small but close objects, or large but distant objects, trigger switching of the operational modes.

The following examples pertain to various aspects of the disclosure as described herein:

In Example 1, an unmanned aerial vehicle is disclosed comprising:

one or more sensors, configured to receive data from an area surrounding the unmanned aerial vehicle;
one or more processors, configured to detect movement in a region surrounding the unmanned aerial vehicle using the sensor data; assess the detected movement for fulfillment of a predetermined movement threshold; and upon fulfillment of the predetermined movement threshold, switch between a first operational mode and a second operational mode.

In Example 2, the unmanned aerial vehicle of Example 1 is disclosed, wherein the first operational mode permits propeller engine initialization, and the second operational mode precludes propeller engine initialization.

In Example 3, the unmanned aerial vehicle of Example 1 is disclosed, wherein a propeller velocity of the second operational mode is less than a propeller velocity of the first operational mode.

In Example 4, the unmanned aerial vehicle of any one of Examples 1 to 3 is disclosed, wherein the one or more processors are configured to convert sensor data from a first period to a first locational map and sensor data from a second period to a second locational map, and to detect movement by comparing the first locational map to the second locational map.

In Example 5, the unmanned aerial vehicle of Example 4 is disclosed, wherein the first locational map and the second locational map are voxel maps.

In Example 6, the unmanned aerial vehicle of Example 4 is disclosed, wherein the first locational map and the second locational map are depth maps.

In Example 7, the unmanned aerial vehicle of any one of Examples 1 to 6 is disclosed, wherein the predetermined movement threshold is movement within a predetermined distance from the unmanned aerial vehicle.

In Example 8, the unmanned aerial vehicle of any one of Examples 1 to 6 is disclosed, wherein the predetermined movement threshold is a percentage of locational map data that differs between a first locational map and a second locational map.

In Example 9, the unmanned aerial vehicle of any one of Examples 1 to 6 is disclosed, wherein the predetermined movement threshold is movement within a predetermined distance from the unmanned aerial vehicle and a percentage of location mapping data that differs between a first locational map and a second locational map.

In Example 10, the unmanned aerial vehicle of any one of Examples 1 to 9 is disclosed, further comprising a memory configured to store the locational mapping data.

In Example 11, the unmanned aerial vehicle of any one of Examples 1 through 10 is disclosed, wherein the sensor is a camera.

In Example 12, the unmanned aerial vehicle of Example 11 is disclosed, wherein the camera is a still camera.

In Example 13, the unmanned aerial vehicle of Example 11 is disclosed, wherein the camera is a video camera.

In Example 14, the unmanned aerial vehicle of Example 11 is disclosed, wherein the camera is an infrared camera.

In Example 15, the unmanned aerial vehicle of Example 11 is disclosed, wherein the camera is a depth-sensing camera.

In Example 16, the unmanned aerial vehicle of any one of Examples 1 to 15 is disclosed, further comprising a plurality of sensors configured to receive data from a region at least partially surrounding the vehicle.

In Example 17, the unmanned aerial vehicle of Example 16 is disclosed, wherein the plurality of sensors are located to receive data from fore, aft, port, and starboard positions of the vehicle.

In Example 18, the unmanned aerial vehicle of Examples 16 or 17 is disclosed, wherein at least one of the plurality of sensors is configured to receive data from a top position of the vehicle.

In Example 19, the unmanned aerial vehicle of any one of Examples 16 through 18 is disclosed, wherein at least one of the plurality of sensors is configured to receive data from a bottom position of the vehicle.

In Example 20, the unmanned aerial vehicle of any one of Examples 1 through 19 is disclosed, wherein the locational mapping data is a voxel map, and the computational circuit detects movement by comparing the voxel map to a voxel map stored in memory.

In Example 21, the unmanned aerial vehicle of any one of Examples 1 to 20 is disclosed, wherein the locational mapping data is a depth map, and the computation circuit detects movement by comparing the depth map to a depth map stored in memory.

In Example 22, the unmanned aerial vehicle of any one of Examples 1 to 21 is disclosed, wherein the locational mapping data comprises a voxel map and a depth map.

In Example 23, the unmanned aerial vehicle of any one of Examples 1 through 22 is disclosed, wherein the one or more processors are further configured to detect movement by identifying changes in location or distance of objects using the received data.

In Example 24, the unmanned aerial vehicle of any one of Examples 1 through 23 is disclosed, wherein the one or more processors are further configured to detect movement by comparing stored sensor data with contemporaneous sensor data.

In Example 25, the unmanned aerial vehicle of any one of Examples 1 through 24 is disclosed, further comprising a plurality of sensors configured to receive data from a lateral circumference of the unmanned vehicle.

In Example 26, the unmanned aerial vehicle of any one of Examples 1 through 25 is disclosed, further comprising the one or more processors switching from the second operational mode to the first operational mode upon reaching a predetermined duration without satisfaction of a predetermined movement threshold.

In Example 27, the unmanned aerial vehicle of any one of Examples 1 through 26 is disclosed, wherein the one or more processors are configured to switch to the second operational mode only when the unmanned aerial vehicle is not airborne.

In Example 28, the unmanned aerial vehicle of Examples 4 or 6 is disclosed, wherein the predetermined distance is between two meters and three meters.

In Example 29, the unmanned aerial vehicle of any one of Examples 1 to 28 is disclosed, wherein the predetermined movement threshold further comprises a percentage of changed pixels or voxels between a first image and a second image.

In Example 30, the unmanned aerial vehicle of Example 29 is disclosed, wherein the percentage of changed pixels or voxels is 15%.

In Example 31, a method of controlling an unmanned aerial vehicle is disclosed comprising:

receiving sensor data of an area surrounding an unmanned aerial vehicle;
detecting movement in a region surrounding the unmanned aerial vehicle from the sensor data;
assessing the detected movement for fulfillment of a predetermined movement threshold; and
switching between a first operational mode and a second operational mode based on fulfillment of the predetermined movement threshold.

In Example 32, the method of Example 31 is disclosed, further comprising converting sensor data from a first period to a first locational map and sensor data from a second period to a second locational map, and detecting movement by comparing the first locational map to the second locational map.

In Example 33, the method of Example 32 is disclosed, wherein the first location map and the second locational map are voxel maps.

In Example 34, the method of Example 33 is disclosed, wherein the first location map and the second locational map are depth maps.

In Example 35, the method of any one of Examples 31 to 34 is disclosed, wherein the predetermined movement threshold is movement within a predetermined distance from the unmanned aerial vehicle.

In Example 36, the method of Example 35, wherein the predetermined movement threshold is a percentage of location mapping data that differs between a first locational map and a second locational map.

In Example 37, the method of Example 35 is disclosed, wherein the predetermined movement threshold is movement within a predetermined distance from the unmanned aerial vehicle and a percentage of location mapping data that differs between a first locational map and a second locational map.

In Example 38, the method of any one of Examples 31 through 37 is disclosed, wherein the sensor data is received from a camera.

In Example 39, the method of Example 38 is disclosed, wherein the camera is a still camera.

In Example 40, the method of Example 38 is disclosed, wherein the camera is a video camera.

In Example 41, the method of Example 38 is disclosed, wherein the camera is an infrared camera.

In Example 42, the method of Example 38 is disclosed, wherein the camera is a depth-sensing camera.

In Example 43, the method of any one of Examples 31 through 42 is disclosed, further comprising receiving data from a plurality of additional sensors arranged to receive data from a region at least partially surrounding the vehicle.

In Example 44, the method of Example 43 is disclosed, wherein the plurality of sensors are located to provide sensory information from fore, aft, port, and starboard positions of the vehicle.

In Example 45, the method of Example 43 or 44 is disclosed, wherein at least one of the plurality of sensors provides a top view of the vehicle.

In Example 46, the method of any one of Examples 43 through 45 is disclosed, wherein at least one of the plurality of sensors provides a bottom view of the vehicle.

In Example 47, the method of any one of Examples 31 through 46 is disclosed, further comprising creating a voxel map of the received data and detecting movement by comparing the voxel map to a voxel map stored in memory.

In Example 48, the method of any one of Examples 31 through 46 is disclosed, further comprising creating a depth map of the received data and detecting movement by comparing the depth map to a depth map stored in memory.

In Example 49, the method of any one of Examples 31 through 48 is disclosed, further comprising detecting movement by identifying changes in location or distance of objects using the received data.

In Example 50, the method of any one of Examples 31 through 49 is disclosed, further comprising detecting movement by comparing stored sensor data with contemporaneous sensor data.

In Example 51, the method of any one of Examples 31 through 50 is disclosed, further comprising receiving data from a lateral circumference of the unmanned vehicle.

In Example 52, the method of any one of Examples 31 through 51 is disclosed, further comprising switching from the second operational mode to the first operational mode upon reaching a predetermined duration without satisfaction of a predetermined movement threshold.

In Example 53, the method of any one of Examples 31 through 52 is disclosed, further switching operational modes only when the unmanned aerial vehicle is not airborne.

In Example 54, the method of any one of Examples 31 through 53 is disclosed, further comprising discontinuing movement detection when the vehicle becomes airborne.

In Example 55, the method of any one of Examples 31 through 54 is disclosed, wherein the predetermined range is between 2 meters and 3 meters.

In Example 56, a means for propeller contact avoidance for an unmanned aerial vehicle comprising:

a sensing means, configured to receive data from a region at least partially surrounding the unmanned aerial vehicle;
a computational means, configured to detect movement in a region surrounding the unmanned aerial vehicle using the sensor data; assess the detected movement for fulfillment of a predetermined movement threshold; and switch between a first operational mode and a second operational mode based on fulfillment of the predetermined movement threshold.

In Example 57, the means of propeller contact avoidance for an unmanned aerial vehicle of Example 56 is disclosed, wherein the predetermined movement threshold is movement within a predetermined distance from the unmanned aerial vehicle.

In Example 58, the means of propeller contact avoidance for an unmanned aerial vehicle of Example 56 is disclosed, wherein the predetermined movement threshold is a percentage of locational mapping data that differs between a first locational map and a second locational map.

In Example 59, the means of propeller contact avoidance for an unmanned aerial vehicle of Example 56 is disclosed, wherein the predetermined movement threshold is movement within a predetermined distance from the unmanned aerial vehicle and a percentage of locational mapping data that differs between a first locational map and a second locational map.

In Example 60, the means of propeller contact avoidance for an unmanned aerial vehicle of any one of Examples 56 to 59 is disclosed, wherein the first operational mode permits propeller engine initialization, and the second operational mode precludes propeller engine initialization.

In Example 61, the means of propeller contact avoidance for an unmanned aerial vehicle of any one of Examples 56 to 60 is disclosed, wherein the second operational mode limits propeller velocity to a velocity less than necessary for flight.

In Example 62, the means of propeller contact avoidance for an unmanned aerial vehicle of Example 56 is disclosed, wherein the sensing means is a camera.

In Example 63, the means of propeller contact avoidance for an unmanned aerial vehicle of Example 56 is disclosed, wherein the sensing means comprises a plurality of cameras.

In Example 64, the means of propeller contact avoidance for an unmanned aerial vehicle of any one of Examples 56 through 63 is disclosed, wherein the computational means is further configured to create a voxel map of the received data, and to detect movement by comparing the voxel map to a voxel map stored in the storing means.

In Example 65, the means of propeller contact avoidance for an unmanned aerial vehicle of any one of Examples 56 through 63 is disclosed, wherein the computational circuit is further configured to create a depth map of the received data, and to detect movement by comparing the depth map to a depth map stored in memory.

In Example 66, the means of propeller contact avoidance for an unmanned aerial vehicle of any one of Examples 56 through 65 is disclosed, wherein the computational means is further configured to detect movement by identifying changes in location or distance of objects using the received data.

In Example 67, the means of propeller contact avoidance for an unmanned aerial vehicle of any one of Examples 56 through 66 is disclosed, wherein the computational means is configured to detect movement by comparing stored sensor data with contemporaneous sensor data.

In Example 68, the means of propeller contact avoidance for an unmanned aerial vehicle of any one of Examples 56 through 67 is disclosed, further comprising the computational means switching from the second operational mode to the first operational mode upon reaching a predetermined duration without satisfaction of a predetermined movement threshold.

In Example 69, the means of propeller contact avoidance for an unmanned aerial vehicle of any one of Examples 56 through 68 is disclosed, further comprising a plurality of sensing means configured to receive data from above the unmanned vehicle.

In Example 70, the means of propeller contact avoidance for an unmanned aerial vehicle of any one of Examples 56 through 69 is disclosed, wherein the computational means is configured to switch between operational modes only when the vehicle is not airborne.

In Example 71, the means of propeller contact avoidance for an unmanned aerial vehicle of any one of Example 57 is disclosed, wherein the predetermined distance is between two meters and three meters.

In Example 72, a non-transient computer readable medium for propeller contact avoidance for an unmanned aerial vehicle is disclosed containing program instructions for causing a computer to perform the method of:

receiving sensor data of an area surrounding an unmanned aerial vehicle;
detecting movement in a region surrounding the unmanned aerial vehicle from the sensor data;
assessing the detected movement for fulfillment of a predetermined movement threshold; and
switching between a first operational mode and a second operational mode based on fulfillment of the predetermined movement threshold.

In Example 73, a non-transient computer readable medium for propeller contact avoidance for an unmanned aerial vehicle is disclosed containing program instructions for causing a computer to perform the method of and of Examples 31 through 55.

In Example 74, an unmanned aerial vehicle is disclosed comprising:

one or more sensors, configured to receive data from an area surrounding the unmanned aerial vehicle;
one or more processors, configured to detect an object in a region surrounding the unmanned aerial vehicle using the sensor data; assess the detected object for fulfillment of a predetermined sensitivity threshold; and upon fulfillment of the predetermined sensitivity threshold, switch between a first operational mode and a second operational mode.

In Example 75, the unmanned aerial vehicle of Example 74 is disclosed, wherein the sensitivity threshold is a size of the detected object.

In Example 76, the unmanned aerial vehicle of Example 74 is disclosed, wherein the sensitivity threshold is a velocity of the detected object.

In Example 77, the unmanned aerial vehicle of Example 74 is disclosed, wherein the sensitivity threshold is a size of the detected object, relative to its proximity.

In Example 78, the unmanned aerial vehicle of Example 74 is disclosed, wherein the sensitivity threshold is a velocity of the detected object.

In Example 79, the unmanned aerial vehicle of Example 74 is disclosed, wherein the first operational mode permits propeller engine initialization, and the second operational mode precludes propeller engine initialization.

In Example 80, the unmanned aerial vehicle of Example 74 is disclosed, wherein a propeller velocity of the second operational mode is less than a propeller velocity of the first operational mode.

In Example 81, the unmanned aerial vehicle of any one of Examples 74 to 80 is disclosed, wherein the one or more processors are configured to convert sensor data from a first period to a first locational map and sensor data from a second period to a second locational map, and to detect fulfillment of the sensitivity threshold by comparing the first locational map to the second locational map.

In Example 82, the unmanned aerial vehicle of Example 81 is disclosed, wherein the first locational map and the second locational map are voxel maps.

In Example 83, the unmanned aerial vehicle of Example 81 is disclosed, wherein the first locational map and the second locational map are depth maps.

In Example 84, the unmanned aerial vehicle of any one of Examples 81 to 83 is disclosed, further comprising a memory configured to store the locational mapping data.

In Example 85, the unmanned aerial vehicle of any one of Examples 74 through 84 is disclosed, wherein the sensor is a camera.

In Example 86, the unmanned aerial vehicle of Example 85 is disclosed, wherein the camera is a still camera.

In Example 87, the unmanned aerial vehicle of Example 85 is disclosed, wherein the camera is a video camera.

In Example 88, the unmanned aerial vehicle of Example 85 is disclosed, wherein the camera is an infrared camera.

In Example 89, the unmanned aerial vehicle of Example 85 is disclosed, wherein the camera is a depth-sensing camera.

In Example 90, the unmanned aerial vehicle of any one of Examples 74 to 89 is disclosed, further comprising a plurality of sensors configured to receive data from a region at least partially surrounding the vehicle.

In Example 91, the unmanned aerial vehicle of Example 90 is disclosed, wherein the plurality of sensors are located to receive data from fore, aft, port, and starboard positions of the vehicle.

In Example 92, the unmanned aerial vehicle of Examples 90 or 91 is disclosed, wherein at least one of the plurality of sensors is configured to receive data from a top position of the vehicle.

In Example 93, the unmanned aerial vehicle of any one of Examples 90 through 92 is disclosed, wherein at least one of the plurality of sensors is configured to receive data from a bottom position of the vehicle.

In Example 94, the unmanned aerial vehicle of any one of Examples 74 through 93 is disclosed, further comprising a plurality of sensors configured to receive data from a lateral circumference of the unmanned vehicle.

In Example 95, the unmanned aerial vehicle of any one of Examples 74 through 94 is disclosed, further comprising the one or more processors switching from the second operational mode to the first operational mode upon reaching a predetermined duration without satisfaction of a predetermined sensitivity threshold.

In Example 96, the unmanned aerial vehicle of any one of Examples 74 through 95 is disclosed, wherein the one or more processors are configured to switch to the second operational mode only when the unmanned aerial vehicle is not airborne.

In Example 97, a method of controlling an unmanned aerial vehicle is disclosed comprising:

receiving sensor data of an area surrounding an unmanned aerial vehicle;
detecting an object in a region surrounding the unmanned aerial vehicle from the sensor data;
assessing the detected object for fulfillment of a predetermined sensitivity threshold; and
switching between a first operational mode and a second operational mode based on fulfillment of the predetermined sensitivity threshold.

What is claimed is:

1. An unmanned aerial vehicle comprising:
one or more sensors, configured to receive data from an area surrounding the unmanned aerial vehicle;
one or more processors, configured to detect movement in a region surrounding the unmanned aerial vehicle using the sensor data; assess the detected movement for fulfillment of a predetermined movement threshold; and upon fulfillment of the predetermined movement threshold, switch between a first operational mode and a second operational mode.

2. The unmanned aerial vehicle of claim 1, wherein the first operational mode permits propeller engine initialization, and the second operational mode precludes propeller engine initialization.

3. The unmanned aerial vehicle of claim 1, wherein a propeller velocity of the second operational mode is less than a propeller velocity of the first operational mode.

4. The unmanned aerial vehicle of claim 1, wherein the one or more processors are configured to convert sensor data from a first period to a first locational map and sensor data from a second period to a second locational map, and to detect movement by comparing the first locational map to the second locational map.

5. The unmanned aerial vehicle of claim 4, wherein the first locational map and the second locational map are voxel maps.

6. The unmanned aerial vehicle of claim 4, wherein the first locational map and the second locational map are depth maps.

7. The unmanned aerial vehicle of claim 1, wherein the predetermined movement threshold is movement within a predetermined distance from the unmanned aerial vehicle.

8. The unmanned aerial vehicle of claim 1, wherein the one or more sensors comprise a depth-sensing camera.

9. The unmanned aerial vehicle of claim 1, wherein the one or more sensors are configured to receive data from at least fore, aft, port, and starboard positions of the vehicle.

10. The unmanned aerial vehicle of claim 1, wherein the locational mapping data is a voxel map, and the computational circuit detects movement by comparing the voxel map to a voxel map stored in memory.

11. A method of controlling an unmanned aerial vehicle comprising:
receiving sensor data of an area surrounding an unmanned aerial vehicle;
detecting movement in a region surrounding the unmanned aerial vehicle from the sensor data;
assessing the detected movement for fulfillment of a predetermined movement threshold; and
switching between a first operational mode and a second operational mode based on fulfillment of the predetermined movement threshold.

12. The method of claim 11, further comprising converting sensor data from a first period to a first locational map and sensor data from a second period to a second locational map, and detecting movement by comparing the first locational map to the second locational map.

13. The method of claim 12, wherein the first location map and the second locational map are voxel maps.

14. The method of claim 12, wherein the first location map and the second locational map are depth maps.

15. The method of claim 11, wherein the predetermined movement threshold is movement within a predetermined distance from the unmanned aerial vehicle.

16. The method of claim 11, wherein the predetermined movement threshold is a percentage of location mapping data that differs between a first locational map and a second locational map.

17. The method of claim 11, wherein sensor data is received from one or more depth-sensing cameras.

18. The method of claim 11, wherein sensor data is received from a plurality of sensors located to provide sensory information from at least fore, aft, port, and starboard positions of the vehicle.

19. The method of claim 11, further comprising creating a voxel map of the received data and detecting movement by comparing the voxel map to a voxel map stored in memory.

20. The method of claim 11, further comprising switching from the second operational mode to the first operational mode upon reaching a predetermined duration without satisfaction of a predetermined movement threshold.
